(19) United States
(12) Patent Application Publication
(10) Pub. No.: US 2016/0207750 A1
(43) Pub. Date: Jul. 21, 2016

(54) METHOD FOR PRODUCING CONTAINERS FILLED WITH A LIQUID

(71) Applicant: KRONES AG, Neutraubling (DE)

(72) Inventors: RUPERT MEINZINGER, Kirchroth (DE); UTE JOHN-UNTERBURGER, Suenching (DE)

(73) Assignee: KRONGES AG, NEUTRAUBLING (DE)

(21) Appl. No.: 14/914,668

(22) PCT Filed: Aug. 29, 2014
(86) PCT No.: PCT/EP2014/068406

§ 371 Date: Feb. 26, 2016

(30) Foreign Application Priority Data
Aug. 29, 2013 (DE) 10 2013 109 378.7

(51) Int. Cl. B67C 3/06; B67C 3/22

(52) U.S. Cl. CPC B67C 3/06; B67C 3/22; B67C 2003/227

(57) ABSTRACT

A method for producing containers filled with a liquid is provided, including the successive steps: producing or providing at least one plastic container; compressing the container in such a way that an internal volume of the container is reduced; filling the compressed container with a liquid, wherein the internal volume of the container is enlarged again by virtue of the filling process.

### CROSS-REFERENCE TO RELATED APPLICATIONS

This application claims priority to PCT Application No. PCT/EP2014/068406, having a filing date of Aug. 29, 2014, based on DE 10 2013 109 378.7, having a filing date of Aug. 29, 2013, the entire contents of which are hereby incorporated by reference.

### FIELD OF TECHNOLOGY

The following relates to a method and an apparatus for producing containers filled with liquids and in particular with beverages. Such methods and apparatuses have been known for a long time in the art. In particular, methods relating to filled plastic containers have also been known for a long time. Usually, plastic containers are produced from plastic preforms, then said plastic containers are filled and capped and are delivered or transported in this capped state.

### BACKGROUND

However, large plastic containers having a capacity of 5 liters (1), 101 or more are also now known from the art. With such plastic containers, there is the problem that these can hold a large filling quantity and can thus also hold a considerable weight and thus are in particular relatively expensive to transport. Particularly in the beer bottling sector, this variant is relatively cost-intensive since, for example, blow-moulding machines do not form part of the usual devices in the context of beer bottling and therefore the procurement thereof is relatively cost-intensive. In particular, however, the expanded containers take up a very large volume, which makes them more difficult to transport.

In a method according to embodiments of the invention for producing containers filled with a liquid, the following steps are carried out in succession:
producing or providing at least one plastic container;
compressing the container in such a way that an internal volume of the container is reduced;
filling the compressed container with a liquid, wherein the internal volume of the container is enlarged again by virtue of the filling process. This preferably takes place at a location different to that at which the container was compressed.

The following steps may optionally also be added:
fitting a cap having a valve-like design (alternatively, however, it would also be possible to fit a screw cap only after the filling process)
attaching a carrying handle after the container has been produced or provided. However, the carrying handle might also be attached only after the container has been compressed.
shipping the compressed containers.

### SUMMARY

An aspect relates to a plastic container that is produced, in particular by a blow-moulding process, and then this container is reduced in size again. Only in a further method step this container is expanded again, in particular, by virtue of a filling process. In this way, it is possible to achieve a situation whereby a bottling plant does not require such blow-moulding machines and nevertheless a relatively small amount of weight has to be transported. In other words, the container can first be brought into a produced but compressed form at a manufacturer and only thereafter expanded by a filling machine. In this case, only devices such as specific filling machines which fill the containers are necessary at the bottler.

However, it would also be possible that the expansion of the ready-manufactured container and the filling take place in separate steps, that is to say that the container is not expanded by virtue of the filling product. In this case, it would be conceivable first to unfold the compressed container again—for instance by means of air pressure—and then to fill the thus unfolded container with a liquid. The applicant reserves the right to claim protection for such a method.

It would also be possible that containers are used multiple times. In this case, the step of producing the container can be omitted and can be replaced by a step of providing the container. Such a container could thus be compressed and then unfolded again multiple times.

In one preferred method, the container is rolled together for compression purposes, so that a mouth region of the container lies within a different region of the container. In this case, the container may be compressed in its longitudinal direction using stamping devices, in such a way that a certain region of the container, in particular an upper region, is pushed or rolled into the lower region. Advantageously, such a compression or rolling of the plastic container takes place along a preferably circumferential folding edge.

In a further preferred method, the container is compressed or rolled together in such a way that it can be stacked with further containers which are compressed or rolled together in the same way. Preferably, however, a container is already produced here which can be stacked in its entirety with a plurality of identical containers.

A further foldable container is described in the formerly unpublished document DE 10 2012 101 868.5 (now published as US 20150047299 A1), the disclosure of which, in particular on pages 7 to 9, is likewise fully incorporated by way of reference into the content of the disclosure of the present application.

Such a container which can be filled with a liquid—which in particular is a plastic Container—has a mouth, a base region and a main body which is formed in one piece with the mouth and the base region. In a folded state of the container, the main body is bent by a predefined bending angle about a predefined circumferential folding edge of the main body in such a way that the mouth of the container is arranged closer to the base region than the circumferential folding edge. According to embodiments of the invention, a relative position (and/or a distance) of the folding edge with respect to the base region of the container can be varied during an expansion of the container. Advantageously, a relative position of the folding edge with respect to the mouth of the container is also variable during an expansion of the container.

There is thus proposed here a foldable container which in particular is folded in such a way that the mouth region is located close to the base region of the container. Advantageously, therefore, the main body itself is folded together by at least one folding edge and preferably with precisely one folding edge. Advantageously, the container is a plastic container. In addition, however, a different foldable material could also be used.

In one preferred embodiment, an outer surface of the main body is located at least in sections circumferentially opposite an inner surface of the main body, in particular in a radial direction of the container. In this way, a very effective reduction of the internal volume is achieved in the folded-together state of the container.

Preferably, the outer surfaces and the inner surfaces of the container are at a spacing of <0.2 cm from one another, at least in sections. Advantageously, this is a circumferential spacing and particularly preferably also a spacing in a radial direction of the container.

In a further advantageous embodiment, a wall thickness of the main body is substantially constant at least in sections (and particularly preferably in the entire region of the main body). It is thus proposed here that it is not for instance a thin-walled region that is placed against another region for folding the container, but rather that preferably a folding of a wall region having a substantially constant wall thickness takes place. Advantageously, said folding edge is also displaceable during an expansion process. Therefore not an immovably located folding edge is proposed about which a folding process is carried out, but rather a displaceable folding region which also migrates during the expansion of the container.

Finally, the formerly unpublished document DE 10 2012 101 868.5 (now published as US 20150047299 A1), also discloses an apparatus and a method by means of which a container can be filled with a liquid and thereby also expanded. The subject matter of said disclosure, in particular the description of the individual method steps and of the associated container on pages 2 to 5, is likewise incorporated by way of reference into the subject matter of the present application.

In a method for filling a container with a liquid, the container is filled via a mouth of the container and an internal volume of the container is enlarged during the filling. The internal volume of the subsequently filled container is at least twice (preferably at least three times, preferably at least five times and particularly preferably at least ten times) the volume of the unfilled container.

It is therefore proposed that the container itself increases in size during the filling process. However, this increase in size does not relate to any minor increase in size which may occur as a result of the filling product being filled into the container. Instead, it is proposed that a substantial increase in volume of the container takes place, in particular precisely as a result of the filling process. The container is, as it were, thus directly “inflated” by the filling product to be filled into the container.

Advantageously, therefore, no stretching or at least no substantial stretching of the wall and/or the material of the plastic container takes place during the filling process, but rather in particular only an unfolding takes place. Preferably, therefore, (besides its mouth) the container to be filled already has its final shape in at least one region of the container, for example in a base region.

It is thus possible in particular that the container produced by the expansion process is folded in such a way that its internal volume is reduced. In the folded state, a predefined wall section and in particular a circumferential wall section preferably lies next to a further predefined wall section and in particular a further circumferential wall section. Advantageously, these wall sections touch one another at least in sections in a folded-together state of the container, and preferably along a circumferential area.

In a further advantageous method, the container is folded or rolled in such a way that a volume ratio between the plastic preform and the container of reduced volume is less than 1:2, preferably 1:1.5 and particularly preferably less than 1:1. Advantageously, a volume ratio between the plastic preform and the unrolled container in the case of a 201 container is 1:50.

During said compressing or folding process, a compression of the material preferably also takes place, which compression is preferably permanent. Preferably, this deformation still exists even after filling under pressure.

Advantageously, the container is deformed in a cold state and in particular without the application of heat. This may mean that, for example, the plastic preforms are cooled after they have been transformed into plastic containers, before they are compressed or folded. However, it may also suffice simply not to further heat the shaped plastic containers.

In a further preferred method, a container cap is fitted to the container after the latter has been produced. Advantageously, in contrast to methods known from the prior art, the cap is fitted before the container is filled with a liquid. It is possible in this case that the cap is fitted to the container before the latter is compressed. However, it would also be possible that the cap is fitted to the container after the latter has been compressed.

It would be possible that a valve cap or a valve-like cap is arranged prior to or after the compression, but it is also possible to fit the cap only after the filling process. In this case, the cap may be a valve cap but may also be a standard screw cap, which is then preferably in turn pierced at the time of emptying the container.

For the capping, therefore, use could be made for example of a valve cap which allows air to escape during the compression. In addition, it is preferably a valve cap through which filling can take place, and with particular preference it is a valve cap through which emptying can also take place.

It is possible that this cap is fitted directly after the blow-moulding process. In addition, use may also be made of a screw cap which is preferably fitted only after the filling process.

In a further method step, it would be conceivable that the container is filled through said cap. Advantageously, this cap may have a valve device which enables filling and emptying of the container. In order to empty this container, preferably a region of the container and in particular of said cap can be pierced.

In a further advantageous method, a container cap is fitted to the container before the latter is compressed. This procedure offers the advantage that it is easier to fit a cap to the produced but not yet compressed container, since in this case the mouth is more easily accessible than in the case of a compressed container. Advantageously, the cap is in this case a cap which allows gas to escape, in particular for the purpose of compressing the container.

In a further preferred method, a plurality of plastic containers are produced and these plastic containers are grouped together in a compressed state to form a container group. Preferably, these containers are stacked one inside the other. The compressed containers could also be stacked on their heads, that is to say upside down, so that the opening is located downwards. In a further preferred method, these container groups could also be palletized. Preferably, the containers are grouped together for transport purposes. It is possible that these container groups are transported from a production site to a site of use. The containers may for instance be produced and also palletized or grouped together by a manufacturing company and then transported to a bottler and then filled with a beverage by the latter. The advantage with this procedure is that the containers can be transported in a very space-saving state.

In a further preferred method, a carrying element is arranged on the container after the latter has been produced. This may be, for example, a carrying handle. As mentioned above, the containers which form the subject matter here are very large and have a considerable weight in a filled state. It is therefore preferred to arrange a carrying element, such as in particular a carrying handle, on these containers. It is possible that this carrying element is arranged on the container immediately after the latter has been produced. However, it would also be conceivable that the carrying element is arranged on the container already at the time of forming or blow-moulding of the latter. Advantageously, the carrying element is arranged on a mouth section of the container.

However, it would also be conceivable that the carrying element is arranged on the container which is in a folded-together state. Furthermore, it is also possible that the carrying element is arranged on the container before the container is capped or after the container is capped. Advantageously, the carrying element can be placed or slid onto a mouth of the container.

In the as yet unpublished patent application No. 10 2013 102 748, such a carrying element is likewise described, as well as a method for attaching this to the container. The subject matter of this disclosure too, in particular pages 4 to 10, is hereby also fully incorporated by way of reference into the subject matter of the present application.

This may be a carrying element for carrying movable bodies. In this case, the carrying element is advantageously flexible at least in sections and has a fastening section by which it can be fastened at least temporarily to a body and in particular to the container. This fastening section preferably has an opening through which at least one section of the container can be passed, and also at least a first gripping section which is connected to the fastening section and which has an opening through which a region of a human hand can be passed. In this case, said opening is preferably delimited by several edge regions, wherein there is arranged on at least one edge region a holding element which is flexible with respect to said edge region and which extends in the direction of the opening.

Advantageously, the carrying element is formed in one piece and particularly preferably is made of a plastic. Advantageously, at least one region of the carrying element is flexible so that it can be bent by an angle of more than 30° , preferably more than 60°. Furthermore, the holding element is also preferably bendable relative to the edge region on which it is arranged, and preferably, as mentioned above, by an angle of at least 30°, preferably at least 60°, preferably at least 90°, preferably at least 120°.

Advantageously, the several of edge regions form a closed circumference. Advantageously, these are edge regions which run in a rectilinear manner at least in sections. Advantageously, the opening has a rectangular cross-section.

In a further advantageous embodiment, the carrying element has in the region of the gripping section a material thickness of between 1 mm and 10 mm, preferably between 2 mm and 4 mm.

In a further advantageous embodiment, there are arranged on the fastening section a plurality of protrusions which, in a state fastened to the body, point towards said body.

Advantageously, the carrying element is detachable from the container that it is intended to carry. In this way, the carrying element can be arranged on the body solely for the purpose of carrying and thereafter can be detached again therefrom.

Preferably, the carrying element is flexible so that it adapts at least in sections to deformations of the container when the container on which it is arranged is folded. For example, the carrying element may bear against a mouth region of the container when the container is folded. In this way, it is also possible that several folded containers are placed one inside the other, in particular for transport purposes, wherein even in this state the carrying element can be fastened to the individual containers.

In a further advantageous embodiment, the container group is transported to a filling device. In particular, the container group may in this case be transported from a manufacturing company to a bottling plant.

In a further advantageous method, the container is labelled after it has been compressed. It is possible in this case that the container is labelled in the compressed state, but it would also be possible that the container is labelled before it is grouped together with several further containers to form a container group. However, it would also be conceivable that the container is labelled only after it has been transported, for example in a bottling plant. In this way, the variability of the bottling plant is increased. Preferably, however, the container is labelled before it is filled.

In this embodiment, the label is preferably arranged on a lower subregion of the container. Instead of labelling, however, it would also be possible that the container is printed, that markings are burned in, for example by means of a laser, and the like. It would also be possible to apply other markings to the container, which for example are characteristic of a bottling date, a date of manufacture, an expiry date and the like.

In a further preferred method, a plastic preform is produced and the plastic container is produced from this plastic preform by a blow-moulding process. Advantageously, the plastic container is produced by a stretch-blow-moulding process. It is preferably possible that the plastic container is produced immediately after production of the plastic preform.

To this end, use is advantageously made of a machine or an apparatus which is placed directly upstream of the transforming device for transforming plastic preforms into plastic containers.

In a further advantageous method, a receiving element for receiving further elements is arranged on the container after the latter has been produced. In this case, it is possible that this receiving element is likewise arranged on a mouth region of the container and/or on a region of the abovementioned carrying element.

This receiving element may be, for example, a so-called blister packaging which preferably has an internal one-way line. This packaging may be arranged, for example, above the carrying element.

The advantage that such a receiving element is present and in particular that the receiving element or the blister packaging is located at the top lies in the fact that a complete container unit can be shipped to the retailer/restaurateur or user; hygienic protection of the cap additionally being provided.

Embodiments of the present invention also relates to an apparatus for producing container groups comprising a plurality of containers, wherein said apparatus includes a container production device which produces plastic containers, a compression device which compresses the produced containers, and a grouping device which groups together a plurality of compressed containers to form a container group.

Preferably, the container production device is a blow-moulding machine and in particular a stretch-blow-moulding machine which transforms plastic preforms into plastic containers. Advantageously, the compression device is arranged downstream of the transforming device or the container production device in a transport direction of the containers, in order to compress the produced containers.

The container grouping device preferably has a stacking device which is suitable for stacking a plurality of produced and compressed containers one inside the other. Furthermore, the apparatus preferably also has a palletizing device which palletizes one or more container groups.

In a further advantageous embodiment, the apparatus has a filling device which fills the compressed containers in particular with a liquid and expands the containers preferably by virtue of this filling process. In this case, the filling device on the one hand and the other aforementioned devices, such as the compression devices, may be arranged in the same machine environment, but preferably these are arranged at locations remote from one another so that the compressed containers or the container groups have to be transported to the filling device by a transport means. The entire machine concept is thus preferably split between different areas or optionally even different regions. The apparatus according to embodiments of the invention also nevertheless makes it possible to save resources since the relatively lightweight container groups can be transported for instance to a bottler and only there can be filled. The containers can also be transported in a very space-saving manner since they are preferably stacked one inside the other as mentioned above.

### BRIEF DESCRIPTION

Some of the embodiments will be described in detail, with reference to the following figures, wherein like designations denote like members, wherein:

In the figure:

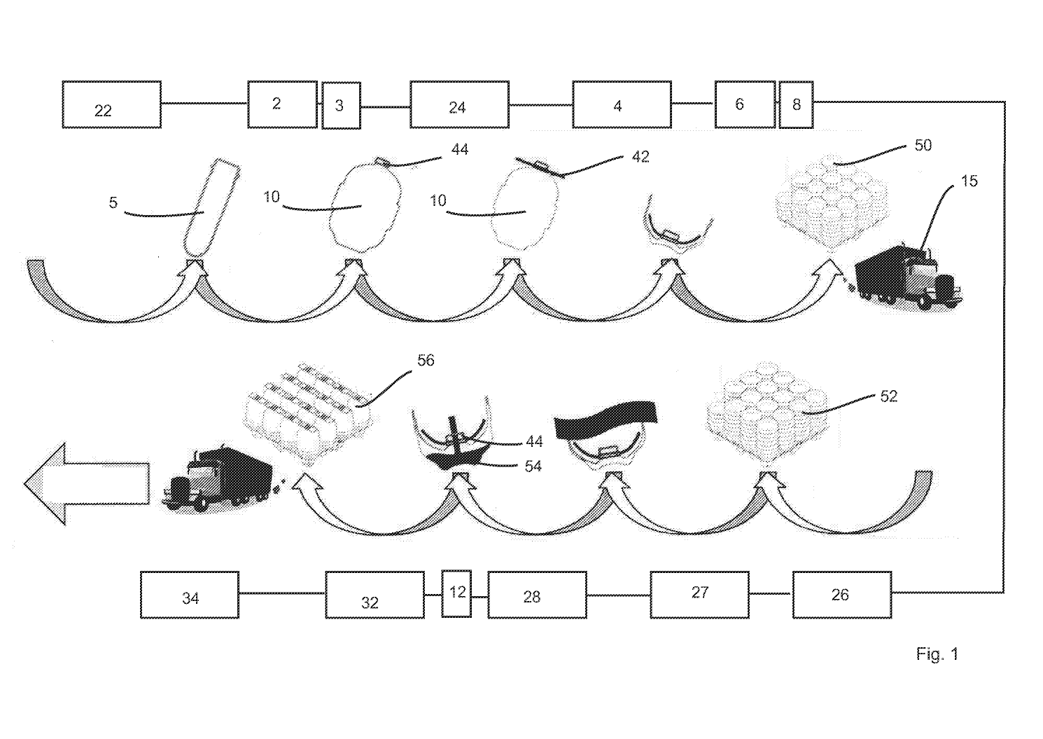

FIG. 1 shows a schematic flowchart of a method and an apparatus;

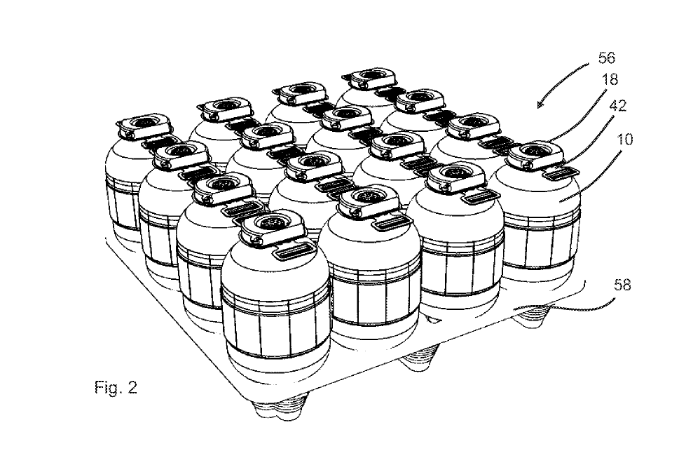

FIG. 2 shows a further diagram of a pallet with containers.

### DETAILED DESCRIPTION

FIG. 1 shows a typical flowchart of a method according to embodiments of the invention. However, it is pointed out that some of the method steps can also be carried out in a different order and that furthermore some of the method steps, such as for example the arranging of a handle on the container, are also optional.

In the context of the method according to embodiments of the invention, firstly plastic preforms 5 are produced by a preform production device 22. The arrows shown in each case below the individual elements illustrate the sequence of the method. This plastic preform 5 may for example be produced at a company, such as for example a converter. In a further method step, the plastic preform 5 is blow-moulded to form a plastic container 10, wherein to this end use is made of a transforming device 2. This transforming device 2 is in particular, but not exclusively, a blow-moulding machine, in particular a stretch-blow-moulding machine.

In a further method step, a cap 44 is arranged on the container, for example is screwed onto the latter. Said cap is in particular a cap having a valve. For this purpose, a capping device 3 is provided, which fits the cap onto the container, for example screws it onto the container (the cap could also be applied by pressing).

In a further method step, a carrying element 42, such as a carrying handle for example, is arranged on the container. Said carrying element may for example be slid over the cap that is already present. Reference 24 denotes a device which for example can attach the carrying handle to the container.

In a further method step, the container is compressed and in particular rolled together in a controlled manner. Reference 4 denotes a suitable device which brings about this rolling or compression process. In contrast to methods known from the art, therefore, here an empty container is compressed in a controlled manner.

In a further method step, a container group 50 is formed from a plurality of compressed containers. To this end, a grouping device 6 is provided. Furthermore, the container groups thus formed are palletized, wherein for example a pallet may hold approximately 500 to 560 containers (in actual fact, the quantity may even be higher, but limitations may arise due to the 40′ height of the container/semitrailer). For this purpose, a palletizer 8 may be provided. Containers may be palletized with the bases at the bottom, but also with the bases at the top, that is to say in a manner resting on the folding ring. However, the containers need not stand on a pallet, but rather they can also be packaged and shipped in a cardboard box with a lid and an internal film.

The containers thus palletized are then transported to a further company, for example a bottler, by a transport means 15, a heavy goods vehicle being shown here.

At the bottling plant, the pallets 52 are first unpacked, for which purpose a depalletizing device 26 is provided (this may also take place manually). In addition, the container groups thus formed can also be separated, more precisely the containers of these container groups are separated, which may take place by a separating device 27 (this may also take place manually).

In a further method step, the containers are labelled by means of a labelling device 28. Advantageously, as mentioned above, the containers may be labelled in a lower half-region of the containers, that is to say a half-region close to the base. However, it would additionally also be possible to label only after the filling process and to apply a sleeve-type label.

In a further method step, the containers are filled and at the same time unrolled. In other words, the containers are filled in an unrolling process, wherein they are preferably also in a closed state by means of the valve cap 44. Reference 12 denotes a corresponding filling device which is also at the same time suitable for expanding the containers by virtue of the filling product. In a further method step, it would also be possible to remove gas or oxygen from a top space of the containers, for example by feeding in other gases, such as nitrogen, by means of an application device after the filling process. In this way, the shelf life of the filling product inside the container can be increased.

By means of a further device, a second cap device, for example a hygiene or safety hood, may (but need not) be fitted to the container or to the cap 44 of the container. Alternatively, it would be conceivable to apply a blister packaging in which a one-way beverage line is located. This blister packaging closes the opening of the cap and can also serve as a hygiene or safety hood.

By means of a further palletizing device 32, the containers which have now been filled are again palletized (and/or strapped, and/or wrapped in film) to form a pallet 56, and finally they can be supplied to the individual customers by a further transport device 34 (a heavy goods vehicle once again being shown here).

However, it would also be possible that the method shown here is carried out with reusable containers, in that for example the abovementioned step of producing the plastic container, for example by means of a blow-moulding process, does not take place but rather a container that is already in existence is rolled up a second time.

FIG. 2 shows a further embodiment of a pallet with containers 10. Here, a receiving element 18 or a receiving device is arranged on the containers 10 in addition to the carrying element. Said receiving element 18 forms a receiving space (not shown), in which further elements, such as a (one-way) tap line and the like, can be accommodated. The receiving element may have an opening which can be pushed or slid over a cap of the container 10.

The applicant reserves the right to claim as essential to embodiments of the invention all the features disclosed in the application documents in so far as they are novel individually or in combination over the prior art.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### LIST OF REFERENCES

2 transforming device
3 capping device
4 compression device
5 plastic preform
6 grouping device
8 palletizer
10 plastic container
12 filling device
15 transport means
18 receiving element
22 preform production device
24 device for attaching the carrying handle
26 depalletizing device
27 separating device
28 labelling device
32 palletizing device
34 transport device
42 carrying element
44 cap
50 container group
52 pallets
56 pallet
58 carrier

1. A method for producing containers filled with a liquid, comprising the successive steps:
producing or providing at least one plastic container;
compressing the container in such a way that an internal volume of the container is reduced;
filling the compressed container with a liquid, wherein the internal volume of the container is enlarged again by virtue of the filling process.

2. The method according to claim 1, wherein a container cap is fitted to the container after the latter has been produced.

3. The method according to claim 1, wherein a container cap is fitted to the container before the latter is compressed.

4. The method according to claim 1, wherein a plurality of plastic containers are produced and these plastic containers are grouped together in a compressed state to form a container group.

5. The method according to claim 1, wherein a carrying element is arranged on the container after the latter has been produced.

6. The method according to claim 4, wherein the container group is transported to a filling device.

7. The method according to claim 1, wherein the container is labelled after it has been compressed.

8. The method according to claim 1, wherein a plastic preform is produced and the plastic container is produced from this plastic preform by a blow-moulding process.

9. The method according to claim 1, wherein a receiving element for receiving further elements is arranged on the container after the latter has been produced.

10. An apparatus for producing container groups comprising a plurality of containers, said apparatus including a container production device which produces plastic containers, a compression device which compresses the produced containers, and a grouping device which groups together a plurality of compressed containers to form a container group.

11. The apparatus according to claim 10, wherein the apparatus includes a filling device which fills the compressed containers with a liquid and expands the containers by virtue of this filling process.
